(19) United States
(12) Patent Application Publication
(10) Pub. No.: US 2012/0096846 A1
(43) Pub. Date: Apr. 26, 2012

(54) WAVE ENERGY CONVERSION SYSTEM

(75) Inventor: Vladimir Kalinin, Omeath (IE)

(73) Assignee: Wavebob Limited, Kildare (IE)

(21) Appl. No.: 12/999,939

(22) PCT Filed: Jun. 18, 2009
(86) PCT No.: PCT/EP2009/057638

§ 371 Date: Oct. 25, 2011

(30) Foreign Application Priority Data
Jun. 19, 2008 (GB) 0811280.7

(51) Int. Cl. F03B 13/18

(52) U.S. Cl. 60/497

(57) ABSTRACT

A wave energy conversion system which includes a wave absorber that moves in response to passing waves. A power take off (PTO) is provided which comprises a plurality of individually selectable actuators. The wave absorber is operable coupled to the actuators for facilitating driving the actuators. Each actuator has an associated damping characteristic. A combination of the damping characteristics of each actuator defines a PTO damping characteristic. A controller is operable to determine a desired PTO damping characteristic in response to a sensed parameter of the wave absorber. The controller is further operable for selectively activating one or more actuators to provide the desired PTO damping characteristic in response to the sensed parameter.

### FIELD OF THE INVENTION

The present invention relates to a wave energy conversion system. In particular the present invention relates to a wave energy conversion system which includes a control means for determining a desired damping in response to a sensed parameter of a wave absorber. The control means is operable for selectively activating one or more actuators to achieve the desired damping.

### BACKGROUND

Wave energy converters are known in the art. Examples of such arrangements include those described in our earlier patents EP1439306, EP1295031 and EP1036274. Such arrangements are usefully deployed in a maritime environment and generate energy from wave motion.

To provide such generation it is known for such converters to employ power take off systems. Typically such systems comprise a hydraulic circuit which is driven by the wave energy which in turn drives a power generator to generate electricity. The hydraulic circuit is controlled such that it remains at a constant pressure so that the electrical power generated by the generator is of a stable frequency. By generating power at a stable frequency permits the power to be readily used in a power grid without the need for complex power electronics. The main disadvantage of constant pressure power take off systems of the type known heretofore is that wave energy absorption is not maximised.

There is therefore a need for a system which optimises wave energy absorption.

### SUMMARY

These and other problems are addressed by providing a power take off system which includes a control means for determining a desired damping in response to a sensed parameter of a wave absorber. The control means is operable for selectively activating one or more actuators to achieve the desired damping.

Accordingly, a first embodiment of the invention provides a wave energy conversion system as detailed in claim 1. Advantageous embodiments are provided in the dependent claims.

These and other features will be better understood with reference to the followings Figures which are provided to assist in an understanding of the teaching of the invention.

### BRIEF DESCRIPTION OF THE DRAWINGS

The present invention will now be described with reference to the accompanying drawings in which:

FIG. 1 is a diagrammatic view of a wave energy conversion system in accordance with the present invention.

FIG. 2 is a detail of the wave energy conversion system of FIG. 1.

FIG. 3 is a graph illustrating the relationship between the damping force of the system of FIG. 1 and the velocity of a wave absorber.

FIG. 4 is a block diagram of a detail of the system of FIG. 1.

### DETAILED DESCRIPTION OF THE DRAWINGS

The invention will now be described with reference to an exemplary system which is provided to assist in an understanding of the teaching of the invention.

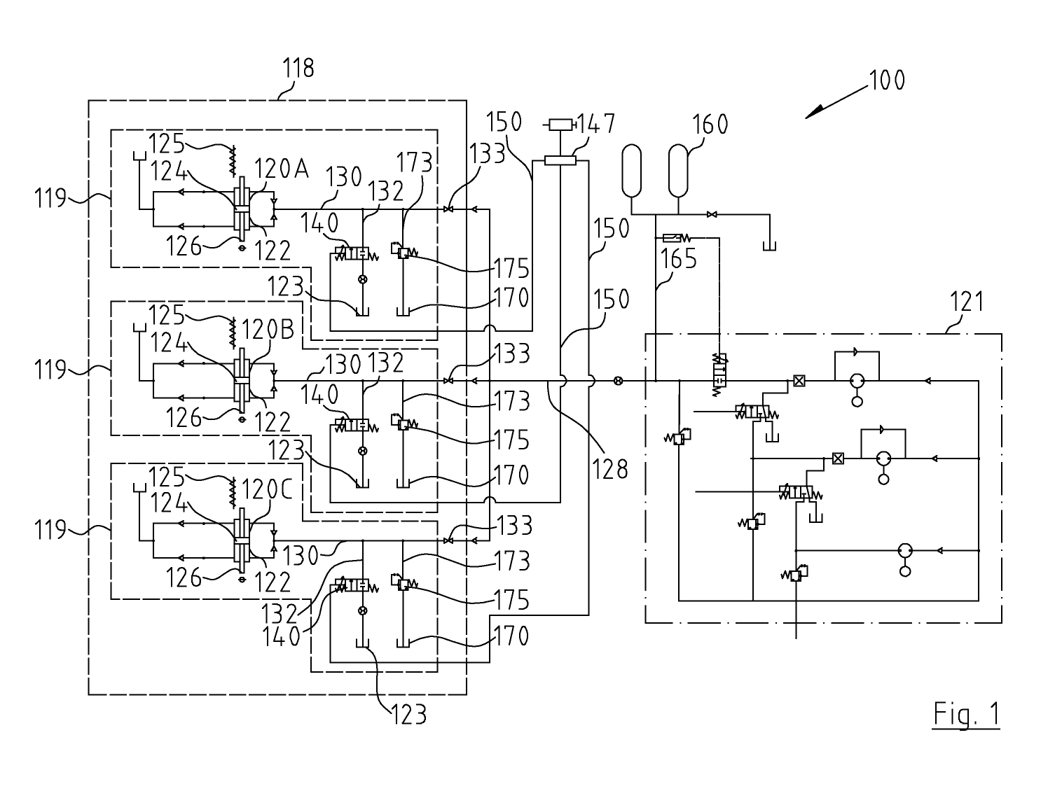

Referring to FIG. 1 there is illustrated a wave energy conversion system 100 which includes a power take off (PTO). The PTO comprises a plurality of actuators to convert wave energy to electricity or some other form of energy. In this exemplary arrangement the actuators are hydraulic pumps, and in the example of FIG. 1 three hydraulic pumps 120 are provided. The pumps 120 are driven by a wave absorber 115, and in turn, drive an energy converter, namely, a power converter 121. The hydraulic pumps 120 may be selectively operated so as to achieve a varying of an operating characteristic of the PTO to a response of a wave absorber 115 to wave action thereon. In this exemplary arrangement, the operating characteristic is a measure of the damping provided by the actuators, and the response of the wave absorber to wave action thereon is provided as a sensed characteristic. The sensed characteristic may be provided as an indication of any one of a number of variable parameters associated with the response of the wave absorber to the wave action. In this exemplary arrangement the sensed characteristic is provided as a measure of the velocity of the wave absorber 115. The damping force of the PTO may be varied such that there is a relationship between the damping force of the system 100 and the velocity of the wave absorber 115. This relationship between the damping force and velocity may be any desired relationship that facilitates wave absorption, and in the exemplary arrangement is substantially linear. Thus, the output of the system 100 is maintained within a predefined operating range, thereby providing a substantially linear output. It will therefore be appreciated that the damping provided by the hydraulic pumps 120 is maintained proportional to the velocity of the wave absorber 115. By providing the power take off (PTO) as a system comprising a plurality of individually selectable actuators with the wave absorber being operably coupled to the actuators for facilitating driving the actuators and each actuator having an associated damping characteristic it will be appreciated that a combination of the damping characteristics of each actuator defines a PTO damping characteristic.

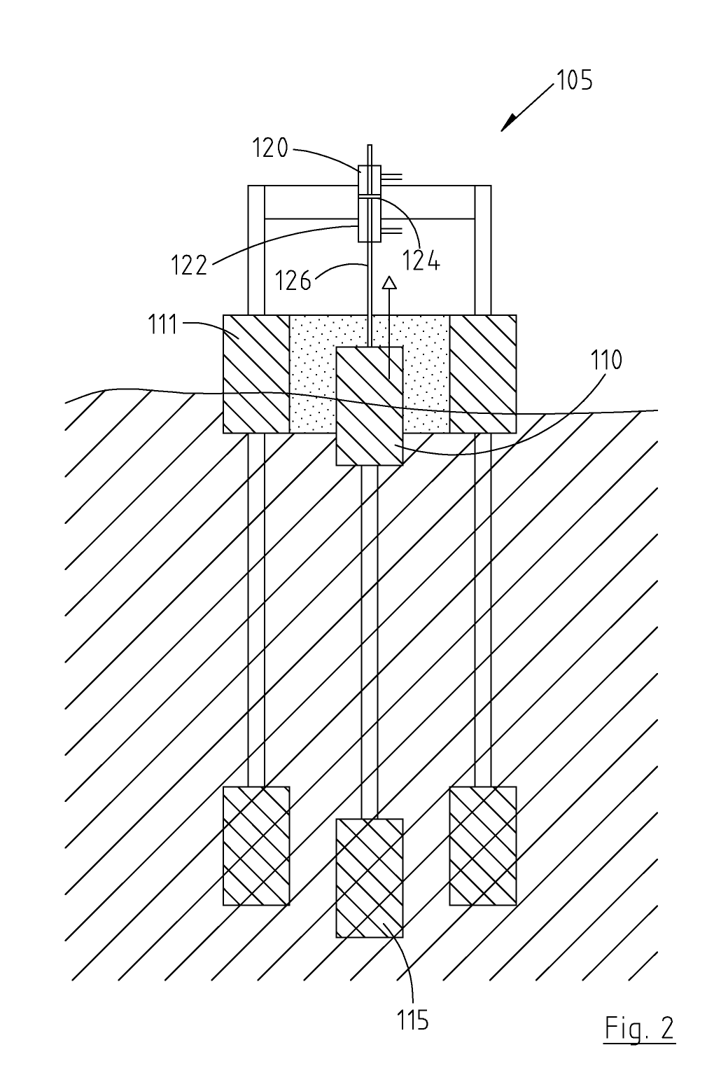

The hydraulic pumps 120 are driven by at least one wave absorbing system 105 for facilitating the conversion of wave energy to, in this exemplary arrangement, electrical energy. Wave energy absorbing systems are known in the art, an example of which is shown in our earlier patent EP 1295031 and replicated in FIG. 2 of the instant application. This exemplary wave energy absorbing system or apparatus 105 comprises a first and second device. The two devices are arranged relative to one another such that the first device may be considered an inner device 110 surrounded by an annular outer device 111. Each of the two devices comprises a surface float and/or at least one submerged wave absorber 115 below the surface of the body of liquid. Linkages are provided between the at least two devices. By configuring each of the two devices to oscillate at different frequencies relative to one another in response to passing waves, relative movement between the at least two devices may be used to generate an energy transfer which may be harnessed by the linkages between the at least two devices 110, 111. The linkages may be coupled to the hydraulic pumps 120 that harnesses the energy generated by the wave absorbing system 105 and converts the wave energy into hydraulic energy. The hydraulic energy from the pumps 120 drives the power converter 121 to generate electricity.

While the wave absorbing system of EP 1295031 is described as employing a power take off system—an example of which is described in FIG. 7 of EP 1295031, the specific implementation described utilises hydraulic pumps, the damping force of which is not controlled to the response of the wave absorber to wave action thereon. The present inventors have realised that in order to maximise wave absorption it is possible to control the damping of the pumps to the response of a wave absorber to wave action thereon. In this exemplary embodiment, the response of the wave absorber to wave action thereon is provided as a sensed characteristic representative of the velocity of the wave absorber. In this way the actual response will be better suited to the conditions prevalent. It will be appreciated by those skilled in the art that the velocity of the wave absorber 115 varies depending on the ocean conditions where the wave absorbing system 105 is moored. The operating characteristic of the system 100 may be dynamically varied during operation as the velocity of the wave absorber 115 changes due to changing ocean conditions. The damping provided by the hydraulic pumps 120 may be varied during a unitary wave period thereby ensuring that the output response changes rapidly and does not have to wait for the next wave period to begin before taking effect. A wave period is the time taken for two consecutive wave troughs to pass a given point. A typical wave pattern will have crests formed by a volume of water between consecutive troughs. A control unit 147 or controller is provided and is operable to vary the damping at different instances during the wave period. Alternatively, the operating characteristic of the system 100 may be tuned by estimating/approximating the velocity of the wave absorber resulting from the prevalent ocean conditions.

The system 100 of FIG. 1 of the instant application is specifically configured to maximise wave energy absorption. The hydraulic pumps 120 are controlled by a control means, namely, a control unit 147 so that the damping force provided by the pumps 120 may be varied in response to changes in velocity of the wave absorber 115. In this way, the wave energy conversion system 100 provides a substantially constant output irrespective of the velocity of the wave absorber 115.

In one exemplary arrangement each hydraulic pump 120 provides a predetermined constant damping force. The constant damping force provided by each hydraulic pump 120 can be chosen to be different to that of the other pumps, or indeed selected ones can have the same and others different. The mechanism for varying the operating characteristic may be for example the selective use of pumps having different dimensions. As there are a plurality of pumps it is possible, in accordance with the teaching of the invention to selectively activate individual ones of the pumps to optimise the response characteristic of the system to the operating conditions of the wave energy absorber 115.

One preferred arrangement is effected by the control unit 147 activating a combination of pumps 120 in a predetermined sequence such that the damping force provided by the pumps is matched to the velocity of the wave absorber 115. As the velocity of the wave absorber 115 increases the control unit 147 dynamically activates a certain combination of pumps 120 so that the damping force of the system 100 also increases. Similarly, as the velocity of the wave absorber 115 decreases the control unit 147 dynamically activates a certain combination of pumps 120 so that the damping force decreases. In this exemplary arrangement, three pumps 120 are provided each providing a different damping force when activated. As three pumps 120 are provided the pumps 120 may be activated in seven combinations, which in turn provide seven different combinations of damping forces from which the control unit 147 can select from. While it will be appreciated that this is a specific example and the teaching should not be restricted to such an exemplary arrangement for the purposes of understanding the number of combinations that are possible it will be seen the seven combinations of damping forces are provided by the following combinations of pumps:
1. Pump 120A,
2. Pump 120B,
3. Pump 120A+Pump 120B,
4. Pump 120C,
5. Pump 120A+Pump 120B+Pump 120C,
6. Pump 120A+Pump 120C, and
7. Pump 120B+Pump 120C.

In this exemplary arrangement, the control unit 147 actives the pumps 120 so that the system 100 has a constant load resistance such that:

R=F/Vₚ

Where:

R is the load resistance,

F is the damping force provided by the active pumps 120, and

Vₚ is the velocity of the wave absorber 115.

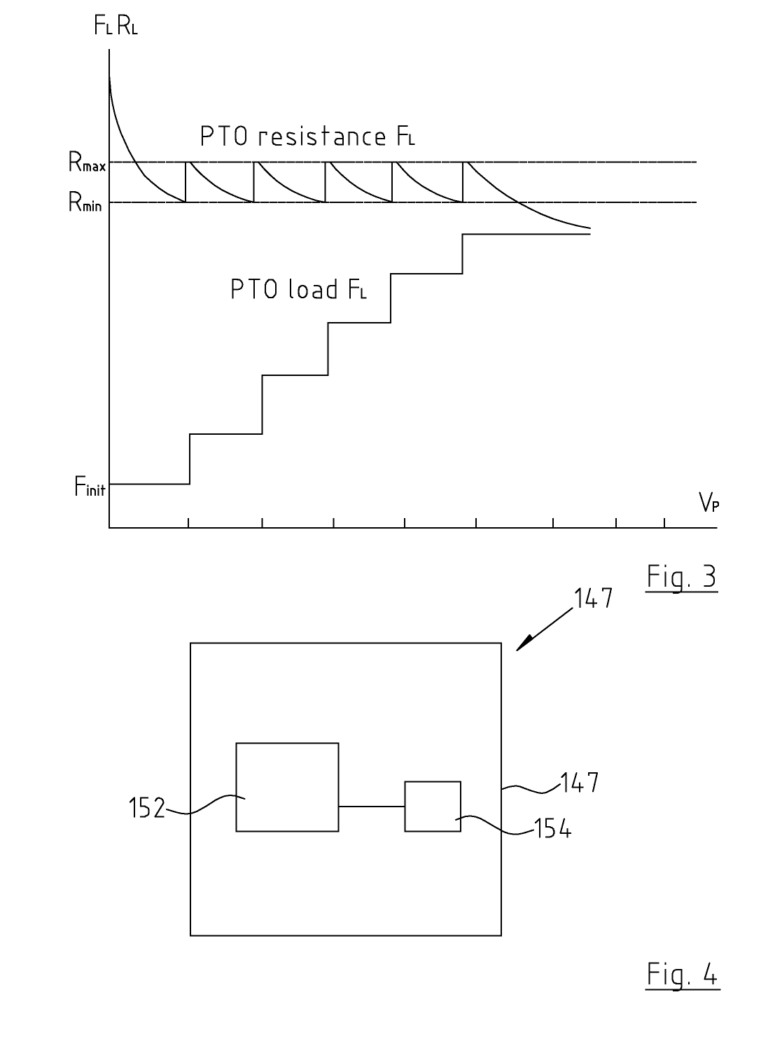

Referring now to the graph of FIG. 3, which shows the damping force F provided by the pumps 120 versus the velocity Vₚ of the wave absorber 115.

The control unit 147 activates the pumps 120 such that there is a substantially linear relationship between the damping force F of the pumps 120 and the velocity Vₚ of the wave absorber 115. The inventors of the present application have realised that by maintaining a substantially predetermined relationship between F and Vₚ, in this case, a linear relationship, it is possible to significantly enhance the quantity of wave energy which may be absorbed by the system 100, and therefore the efficiency of the overall system. For example, if the velocity Vₚ is within a first range, the control unit 147 may activate pump 120A such that the system 100 has a corresponding first damping force. If the velocity Vₚ is within a second range, the control unit 147 may activate pump 120B such that the system 100 has a corresponding second damping force. If the velocity Vₚ is within a third range, the control unit 147 may activate pumps 120A and 1208 such that the system 100 has a corresponding third damping force. If the velocity Vₚ is within a fourth range, the control unit 147 may activate pumps 120C such that the system 100 has a corresponding fourth damping force. If the velocity Vₚ is within a fifth range, the control unit 147 may activate pumps 120A, 120B and 120C such that the system 100 has a corresponding fifth damping force. If the velocity Vₚ is within a sixth range, the control unit 147 may activate pumps 120A and 120C such that the system 100 has a corresponding sixth damping force. If the velocity Vₚ is within a seventh range, the control unit 147 may activate pumps 120B and 120C such that the system 100 has a corresponding seventh damping force. Thus, it will be appreciated by those skilled in the art that the control unit 147 may be configurable to dynamically activate and/or deactivate predetermined pumps 120 at different instances during a single wave period so that there is a substantially linear relationship between F and Vₚ. In other words, the controller or control unit 147 is configured to dynamically activate various combinations of pumps during the time period for two consecutive wave troughs to pass a given point. The control unit thereby achieves a tuning of the response of the PTO throughout the passage of individual waves. In this way the response of the device is not restricted to a single response characteristic for a single wave. A single wave may require a modification of the damping forces at multiple iterations during the passage of that single wave. It will be appreciated by those skilled in the art that as the pumps 120 are selectively activated and/or deactivated it is possible to vary the operating characteristic of the system 100 to the sensed characteristic. At least one of the pumps 120 may be activated and another one of the pumps 120 deactivated simultaneously. Alternatively, at least two pumps 120 may be activated simultaneously, and at least two pumps 120 deactivated simultaneously. The pumps 120 may be operated in a sequence.

In this exemplary arrangement, the system 100 comprises a network 118 of hydraulic pumping circuits 119 which are driven by wave energy for pumping fluid from reservoirs 123 to the power generator 121. The pumped fluid drives the power generator 121 to generate electrical energy. Each pumping circuit 119 has an associated damping force. The pumping circuits 119 are selectively activated and/or deactivated for actively varying the damping force of the PTO system 100 to be dynamically matched with the velocity of the wave absorber 115 of the wave absorbing system 105.

Each pumping circuit 119 comprises a hydraulic pump 120 with corresponding wave absorbing rams 124 axially moveable in cylinders 122 and operably coupled to the wave absorbing system 105 by a coupling shaft 126. As the submerged wave absorbing body 115 oscillates due to wave energy it provides a driving force to the rams 124 via the coupling shaft 126, which in turn forces the rams 124 to oscillate. Position sensors 125 sense the movement of the rams 124. The control unit 147 is in communication with the position sensors 125 for calculating the velocity of the rams 124, which in turn calculates the velocity of the wave absorber 115. Depending on the velocity of the wave absorber 115 certain pumps 120 are activated so that there is a substantially linear relationship between the damping force of the system 100 and the velocity of the wave absorber 115. The oscillating rams 124 pump fluid from the reservoirs 123 to the power generator 121. The pumping circuits 119 are in fluid communication with the power generator 121 via a primary hydraulic circuit 128. Each pumping circuit 119 comprises a main line 130 extending between the pump 120 and the primary circuit 128 and coupled thereto by a coupling valve 133. A supply line 132 extends between each reservoir 123 and corresponding main line 130 which ensures that the reservoirs 123 are in fluid communication with the pumps 120. A flow control means, in this case, a bidirectional pneumatic valve 140 is located in each supply line 132 intermediate the main lines 130 and the reservoirs 123, and are selectively controlled for activating and/or deactivating the corresponding pumps 120. It will be appreciated by those skilled in the art that the activated pumps 120 contribute to the damping force of the overall system 100. Deactivated pumps 120 do not contribute to the damping force of the overall system 100.

The damping force of each pumping circuit 119 is set by the dimensions of the pumps 120. In this exemplary arrangement three pumping circuits 119 are provided and each pumping circuit 119 has a different damping force as the pumps 120 have different dimensions. The transverse cross sectional area of the rams 124 and the corresponding cylinders 122 progressively increase from the first pump 120A to the third pump 120C. While the preferred arrangement includes three pumping circuits 119 it will be appreciated by those skilled in the art that any desired number of pumping circuits 119 may be provided. It is not intended to limit the invention to this described arrangement. It will be appreciated by those skilled in the art that the pumping circuits herein described are exemplary of the type of circuitry that may be employed to match the response of the PTO to the climatic conditions of the wave absorbing system.

The control unit 147 is operably coupled to the pneumatic valves 140 by electrical cables 150 for providing control signals to the pneumatic valves 140 which selectively activate and/or deactivate the pneumatic valves 140, which in turn selectively activates and/or deactivates the corresponding pumps 120. The control unit 147 comprises a microprocessor 152 and a memory chip 154 which stores a control algorithm. The microprocessor 152 calculates the velocity of the wave absorber 115 by communicating with the position sensors 125 and generates an optimised damping force which the system 100 needs to have in order to optimise wave absorption. Tables containing velocity data and corresponding damping force data may be preloaded to the memory chip 154 which can then be read by the microprocessor 152 for selecting the optimum damping force. The control unit 147 controls the pneumatic valves 140 based on the velocity of the wave absorber 115 so that the overall damping force of the system 100 is set at the optimised value. The control unit 147 may be operable to communicate with local and/or remote data systems for receiving data for populating the tables in the memory chip 154. This data may then be used for estimating/approximating/determining the appropriate damping force of the system 100. The data systems which supply data to the control unit 147 may include a weather system. The data received by the control unit 147 may be historical data representative of seasonal wave conditions. Additionally or alternatively, the data may be real-time data representative of real-time wave conditions. It will be appreciated by those skilled in the art that the data received may be any type of data which can be used for selecting an optimum damping force. The control unit 147 may be in wireless communication with the data systems.

A pressure accumulator 160 is operably coupled to the primary circuit 128 via an interconnecting circuit 165 for maintaining the pressure in the primary circuit 128 constant. It will be appreciated that wave energy varies significantly depending on the conditions in the ocean. In periods of large swells, the wave energy absorbing system 105 generates a large amount of kinetic energy which drives the pumps 120 at a high rate so that the fluid in the primary circuit 128 is under high pressure. In periods of relatively small swells, the kinetic energy generated by the wave energy absorbing system 105 is significantly less than periods of large swells resulting in less kinetic energy and as a consequence the pumps 120 are driven at a slower rate resulting in the fluid in the primary circuit 128 being under less pressure. The pressure accumulator 160 regulates the pressure within the primary circuit 128 so that the pressure in the primary circuit 128 remains substantially constant. Overflow wells 170 are in fluid communication with each main line 130 via outlet lines 173 for receiving fluid from the primary circuit 128 when pressure in the primary circuit 128 exceeds a threshold level. A unidirectional valve 175 is provided in each outlet line 173 for controlling the flow of fluid to the overflow wells 170.

In operation, the pumps 120 are operably coupled to the wave absorbing system 105. The submerged wave absorber 115 of the wave energy absorbing system 105 is forced to oscillate by the wave energy, which in turn provides a driving force which drives the rams 124 to pump fluid to the power generator 121. The pumped fluid to the power generator 121 drives the power generator 121 to generate electricity. The control unit 147 dynamically activates one of seven combinations of pumps 120 sequentially so that there is a substantially linear relationship between the damping force of the system 100 and the velocity of the wave absorber 115. As the wave absorber of this specific example generates energy from relative motion of two devices in response to passing waves its movement effects a driving of the rams to move bi-directionally. In other words, the wave absorber 115 pushes the rams 124 of the pumps 120 in an upwardly direction when the wave absorber 115 moves towards the surface of the water, and pulls the rams 124 in a downwardly direction when the wave absorber 115 sinks to a lower depth. In certain instances, it may be desirable to increase the potential energy which the wave absorber 115 provides by urging the wave absorber 115 to a lower depth. The pumps 120 may be controlled by the control unit 147 to drive the wave absorber 115 downwardly. It will therefore be appreciated that while the wave absorber 115 drives the pumps 120 for the majority of the time, in certain instances the pumps 120 drive the wave absorber 115 to increase the potential energy of the wave absorber 115. It will therefore be understood that the wave absorber 115 drives the pumps 120 for major portion of an operating cycle of the wave energy conversion system 100, while the PTO drives the wave absorber 115 for a minor portion of the operating cycle.

It will be understood that what has been described herein is an exemplary embodiment of a wave energy conversion system. While the present invention has been described with reference to exemplary arrangements it will be understood that it is not intended to limit the teaching of the present invention to such arrangements as modifications can be made without departing from the spirit and scope of the present invention. For example, in the exemplary arrangement the predetermined relationship between F and Vₚ has been described as being substantially linear. It will be appreciated by those skilled in the art that the relationship between F and Vₚ may be non-linear. It will be understood that the invention is to be limited only insofar as is deemed necessary in the light of the appended claims.

The words comprises/comprising when used in this specification are to specify the presence of stated features, integers, steps or components but does not preclude the presence or addition of one or more other features, integers, steps, components or groups thereof.

1. A wave energy conversion system comprising:
a wave absorber being moveable in response to passing waves;
a power take off (PTO) comprising a plurality of individually selectable actuators, the wave absorber being operably coupled to the actuators for facilitating driving the actuators, each actuator having an associated damping characteristic, a combination of the damping characteristics of each actuator defining a PTO damping characteristic;
a controller operable to determine a desired PTO damping characteristic in response to a sensed parameter of the wave absorber, the controller being further operable for selectively activating one or more actuators to provide the desired PTO damping characteristic in response to the sensed parameter, wherein at least two actuators differ in dimensions.

2. A system as claimed in claim 1, wherein the wave absorber is operable to move the actuators bi-directionally.

3. A system as claimed in claim 2, wherein the wave absorber is operable for pushing and/or pulling the actuators.

4. A system as claimed in claim 1, wherein the PTO is operable to drive the wave absorber to a submerged depth to increase the potential energy of the wave absorber.

5. A system as claimed in claim 4, wherein the wave absorber drives the actuators for a major portion of an operating cycle, and the PTO drives the wave absorber for a minor portion of the operating cycle.

6. A system as claimed in claim 1, wherein the controller is configured to selectively activate a combination of actuators in response to a change in the sensed parameter.

7. A system as claimed in claim 6, wherein the controller is configured to selectively activate two or more actuators in response to a change in the sensed parameter.

8. A system as claimed in claim 1, wherein the controller is configured to selectively deactivate one or more actuators in response to a change in the sensed parameter.

9. A system as claimed in claim 1, wherein the controller is configured to effect activation of at least one of the actuators and deactivation of another of the actuators simultaneously.

10. A system as claimed in claim 9, wherein the controller is configured to provide for simultaneous activation of at least two actuators.

11. A system as claimed in claim 9, wherein the controller is configured to provide for simultaneous deactivation of at least two actuators.

12. A system as claimed in claim 1, wherein the sensed parameter comprises a velocity of the wave absorber.

13. A system as claimed in claim 1, wherein the controller is configured to control the actuators to vary the PTO damping characteristic during a time period for two consecutive wave troughs to pass a given point.

14. A system as claimed in claim 12, wherein the controller is operable for dynamically activating and/or deactivating predetermined actuators at different instances during a single wave period.

15. A system as claimed in claim 12, wherein the controller is operable for dynamically activating various combinations of actuators at different instances during a time period for two consecutive wave troughs to pass a given point.

16. A system as claimed in claim 1, wherein the controller is configured to operate the actuators in a sequence.

17. A system as claimed in claim 1, wherein the controller controls the actuators for controlling a load resistance of the system.

18. A system as claimed in claim 17, configured such that operably the damping force provided by the actuators is proportional to a velocity of the wave absorber.

19. A system as claimed in claim 17, configured such that the load resistance may be varied during a unitary wave period.

20. A system as claimed in claim 1, wherein the controller is configured to change which actuators are active during a unitary wave period.

21. A system as claimed in claim 1, wherein at least some of the actuators are configured to provide different damping.

22. (canceled)

23. A system as claimed in claim 1, wherein the wave absorber is operably provided below surface of the wave.

24. A system as claimed in claim 23 wherein the wave absorber is operably coupled to a surface float.

25. A system as claimed in claim 23, wherein the actuators are provided intermediate the wave absorber and the surface float.

26. A system as claimed in claim 24, wherein the wave absorber is suspended from the surface float.

27. A system as claimed in claim 23, wherein the surface float is surrounded by an annular surface float.

28. A system as claimed in claim 27, wherein the surface floats and the annular surface float are configured to oscillate at different frequencies relative to one another in response to the passing waves.

29. A system as claimed in claim 1, wherein the wave absorber is submerged.

30. A system as claimed in claim 1, wherein the actuators are provided as hydraulic pumps with associated rams.

31. A system as claimed in claim 30, wherein the rams are operably coupled to the wave absorber.

32. A system as claimed in claim 30, wherein the wave absorber is operable to push and/or pull the rams.

33. A system as claimed in claim 30, wherein at least some of the rams differ in dimensions.

34. A system as claimed in claim 30, wherein at least some of the rams have different cross sectional area.

35. A system as claimed in claim 30, wherein the wave absorber drives the rams with mechanical energy.

36. A system as claimed in claim 35, wherein the hydraulic pumps are operable to convert the mechanical energy provided by the wave absorber into hydraulic energy.

37. A system as claimed in claim 1, wherein the controller is operable to communicate with data systems for receiving data.

38. A system as claimed in claim 36, wherein the received data is used by the controller for determining the desired PTO damping characteristic.

39. A system as claimed in claim 37, wherein the controller is communicable with a weather system for facilitating the transmission of data there between.

40. A system as claimed in claim 37, wherein the data comprises historical data representative of seasonal wave conditions.

41. A system as claimed in claim 37, wherein the data is real-time data representative of real-time wave conditions.

42. A system as claimed in claim 37, wherein the controller is configured to be in wireless communication with the data systems.

43. (canceled)

44. A wave energy conversion system comprising:
a wave absorber being moveable in response to passing waves;
a power take off (PTO) comprising a plurality of individually selectable hydraulic pumps with associated rams, the wave absorber being operably for driving the hydraulic pumps, each hydraulic pump having an associated damping characteristic, a combination of the damping characteristics of each hydraulic pump defining a PTO damping characteristic.
a controller operable to determine a desired PTO damping characteristic in response to a sensed parameter of the wave absorber, the controller being further operable for selectively activating one or more hydraulic pumps to provide the desired PTO damping characteristic in response to the sensed parameter, wherein at least two rams differ in dimensions.
